(19) United States
(12) Patent Application Publication
(10) Pub. No.: US 2018/0336504 A1
(43) Pub. Date: Nov. 22, 2018

(54) SIMULATION METHOD, SIMULATION APPARATUS, AND RECORDING MEDIUM

(71) Applicant: FUJITSU LIMITED, Kawasaki-shi (JP)

(72) Inventor: Shohei YAMANE, Kawasaki (JP)

(73) Assignee: FUJITSU LIMITED, Kawasaki-shi (JP)

(21) Appl. No.: 15/980,121

(22) Filed: May 15, 2018

(30) Foreign Application Priority Data
May 16, 2017 (JP) 2017-097687

(51) Int. Cl. G06Q 10/06; G06Q 30/02; G06F 9/455

(52) U.S. Cl. CPC G06Q 10/067; G06F 9/455; G06Q 30/0201

(57) ABSTRACT

A non-transitory computer-readable recording medium stores therein a simulation program that causes a computer to execute a process including: first directing an agent to visit and evaluate a plurality of selection candidates, the agent making a selection from the plurality of candidates, the agent evaluating the plurality of candidates by utilizing an expected value preset to each of the plurality of selection candidates; second directing the agent to determine whether to continue visiting and evaluating the plurality of candidates, based on evaluation results of visited selection candidates and the expected values of an unvisited selection candidates; and third directing the agent to make a selection from the plurality of selection candidates based on the evaluation results of the visited selection candidates in a case in which the agent determines not to continue visiting and evaluating.

### CROSS-REFERENCE TO RELATED APPLICATION

This application is based upon and claims the benefit of priority of the prior Japanese Patent Application No. 2017-097687, filed on May 16, 2017, the entire contents of which are incorporated herein by reference.

### FIELD

The embodiments discussed herein are related to a simulation method, a simulation apparatus, and a recording medium.

### BACKGROUND

A simulation technique has been known which maximizes an evaluation value. For example, the following has been known: a technique related to an office environment simulator which simulates an office environment and includes a state display unit, a decision-making selection menu, an evaluation function calculation unit, a history information storage unit, and a comparison unit that compares a target value with an evaluation function (see Japanese Laid-open Patent Publication No. 06-103261). In the technique, in a case in which the comparison result of the comparison unit is less than the target value, a process is repeated which notifies the state display unit of the fact and displays both the current state of the office and information indicating that the comparison result is less than the target value (for example, information indicating that a comfort index is less than a target value). In addition, the technique analyzes the behavior of the user after simulations based on the stored history information, indicates a desired behavior (selection), and increases the learning effect of office environment management by the user.

A simulation method has been known which, in a case in which a user visits facilities, such as stores, selects a facility to be visited by the user based on preference to the facility and a time restriction (see Takumi Yoshida, Toshiyuki Kaneda: An Architecture and development Framework for Pedestrians' Shop-Around Behavior Model inside Commercial district by using Agent-Based Approach, CUPUM'07 (2007) Paper 135, pp. 16). The technique probabilistically determines whether the user can visit the selected facility and achieve the user's purpose. Then, the technique determines the facility to be visited by the user based on whether the purpose can be achieved.

However, in a case in which the user goes shopping at the stores, the user performs a selection behavior of selecting a store to visit. However, in the above-mentioned technique, it is difficult to allocate an expected value indicating expectations to a selection candidate in advance. Therefore, it is difficult to determine whether to continue or end a confirmation operation based on the expectations of the user. That is, it is difficult to perform a simulation in which an expected value based on the past experience of the user or the hobby and taste of the user is reflected.

According to the above-mentioned technique, in some cases, it is difficult to dynamically change the selection behavior of the user based on the presence of a confirmed selection candidate or an unconfirmed selection candidate. For example, in a case in which there are many selection candidates, the selection is likely to end before the selection candidate with a high expected value is evaluated. In this case, the selection candidate with the highest expected value is not likely to be selected.

### SUMMARY

According to an aspect of the embodiment, a non-transitory computer-readable recording medium stores therein a simulation program that causes a computer to execute a process including: first directing an agent to visit and evaluate a plurality of selection candidates, the agent making a selection from the plurality of candidates, the agent evaluating the plurality of candidates by utilizing an expected value preset to each of the plurality of selection candidates; second directing the agent to determine whether to continue visiting and evaluating the plurality of candidates, based on evaluation results of visited selection candidates and the expected values of an unvisited selection candidates; and third directing the agent to make a selection from the plurality of selection candidates based on the evaluation results of the visited selection candidates in a case in which the agent determines not to continue visiting and evaluating.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of the functional configuration of a simulation apparatus according to a first embodiment;

FIG. 2 is a diagram illustrating an example of the flow of a process performed by the simulation apparatus according to the first embodiment;

FIGS. 3A and 3B are diagrams illustrating the effect of the simulation apparatus according to the first embodiment;

FIGS. 4A to 4G are diagrams illustrating the content of the process performed by the simulation apparatus according to the first embodiment;

FIG. 5 is a flowchart illustrating the flow of the process performed by the simulation apparatus according to the first embodiment;

FIG. 6 is a block diagram illustrating an example of the functional configuration of a simulation apparatus according to a second embodiment;

FIGS. 7A to 7C are diagrams illustrating the content of a process performed by the simulation apparatus according to the second embodiment;

FIG. 8 is a flowchart illustrating the flow of the process performed by the simulation apparatus according to the second embodiment;

FIG. 9 is a block diagram illustrating an example of the functional configuration of a simulation apparatus according to a third embodiment;

FIGS. 10A to 10D are diagrams illustrating the content of a process performed by the simulation apparatus according to the third embodiment;

FIG. 11 is a flowchart illustrating the flow of the process performed by the simulation apparatus according to the third embodiment;

FIG. 12 is a block diagram illustrating an example of the functional configuration of a simulation apparatus according to a fourth embodiment;

FIG. 13A to 13D are diagrams illustrating the content of a process performed by the simulation apparatus according to the fourth embodiment;

FIG. 14 is a flowchart illustrating the flow of the process performed by the simulation apparatus according to the fourth embodiment;

FIG. 15 is a block diagram illustrating an example of the hardware configuration of the simulation apparatus according to the first embodiment;

FIG. 16 is a diagram illustrating an example of the flow of a simulation according to the related art; and

FIGS. 17A and 17B are diagrams illustrating the problem of the simulation according to the related art.

### DESCRIPTION OF EMBODIMENTS

### [a] First Embodiment

Preferred embodiments will be explained with reference to accompanying drawings. The simulation program, the simulation method, and the simulation apparatus described in the following embodiments are illustrative and do not limit the embodiments. The following embodiments may be appropriately combined with each other in the range in which the embodiments are consistent with each other.

Selection Behavior Simulation Method According to Related Art

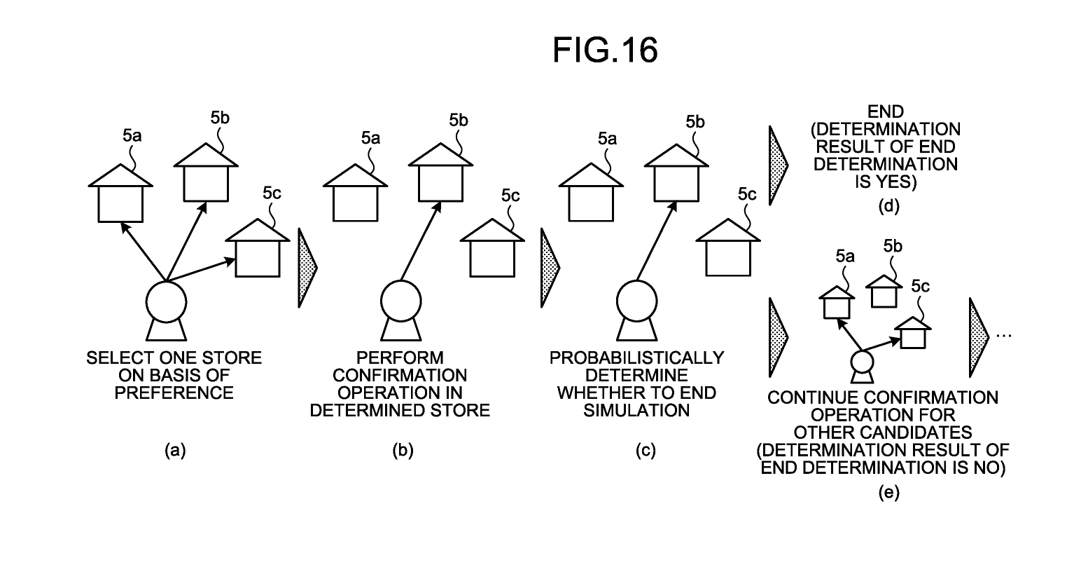

First, the problems of a selection behavior simulation according to the related art will be described as a comparative example. FIG. 16 is a diagram illustrating an example of the flow of a simulation according to the related art.

In the related art, first, one store to visit is determined from a plurality of stores 5a, 5b, 5c, . . . based on preference to each of the stores 5a, 5b, 5c, . . . and restriction conditions such as a time restriction and a distance restriction (FIG. 16(a)). Then, the user visits the determined store, for example, the store 5b and performs a confirmation operation of evaluating whether the store 5b is matched with the preference (FIG. 16(b)). Then, it is probabilistically determined whether to end the simulation based on whether the purpose of purchasing a favorite item has been achieved (FIG. 16(c)). In a case in which it is determined that the purpose has been achieved in FIG. 16(c), it is determined that the selection behavior has ended and the simulation ends (FIG. 16(d)). On the other hand, in a case in which it is determined that the purpose has not been achieved in FIG. 16(c), the same evaluation is repeatedly performed for each store which has not been visited (FIG. 16(e)).

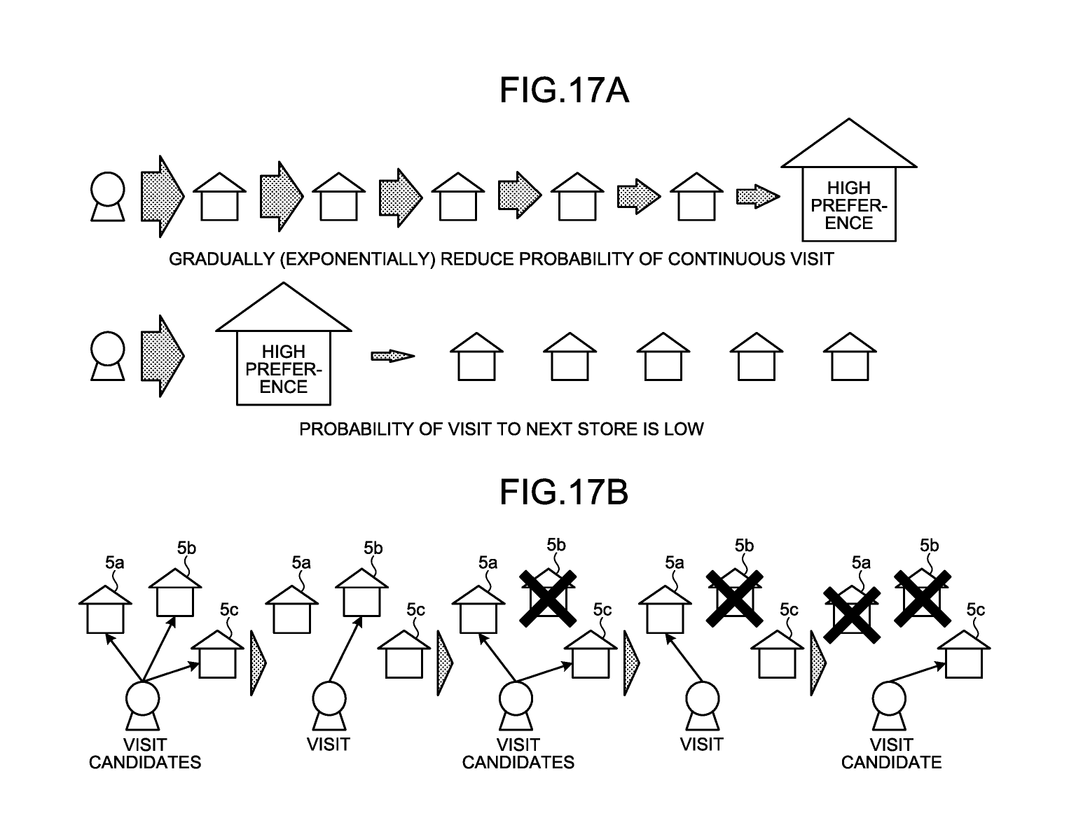

The related art has the problem illustrated in FIGS. 17A and 17B. That is, the store which has not been visited indirectly affects the selection behavior only by increasing or decreasing the probability of the store being closed. Therefore, the selection result of the store is likely to be affected by a store visit order (FIG. 17A). Specifically, in a case in which there are a large number of stores, the probability of the user continuously visiting the stores is gradually reduced whenever the user repeatedly visits the stores. Therefore, before the user visits a favorite store, the user is likely to end selection. In addition, in a case in which the user visits a favorite store first, the probability of the user visiting the next store is reduced. As a result, the favorite store is selected. Therefore, in a case in which the stores which have not been visited include a favorite store, the user is not likely to select the store.

In addition, the related art has the problem that it is difficult to determine the store which has been visited once as the selection candidate again. Specifically, the store 5b which has been visited once and is determined not to be preferred is excluded from the selection candidates at that time. Therefore, it is difficult for the user to return to the store 5b and to perform evaluation again (FIG. 17B). As a result, it is difficult to simulate the behavior of the user returning to the store which has been visited once and performing evaluation again.

As such, in the simulation method according to the related art, it is difficult to dynamically change the selection behavior according to whether the candidate (store) that has been confirmed in the past or an unconfirmed candidate is present.

Configuration of First Embodiment

A first embodiment relates to a simulation apparatus 1 that simulates a selection behavior of selecting a store matched with the preference (taste) of a consumer that is the user of the store from a plurality of stores that handle items belonging to different categories in a facility having a plurality of tenants such as a department store. The store is an example of a selection candidate. The simulation apparatus 1 simulates the selection behavior of the consumer, who has an item category to be purchased and visits a facility such as a department store, sequentially visiting a plurality of stores and purchasing the item in the store matched with the consumer's preference.

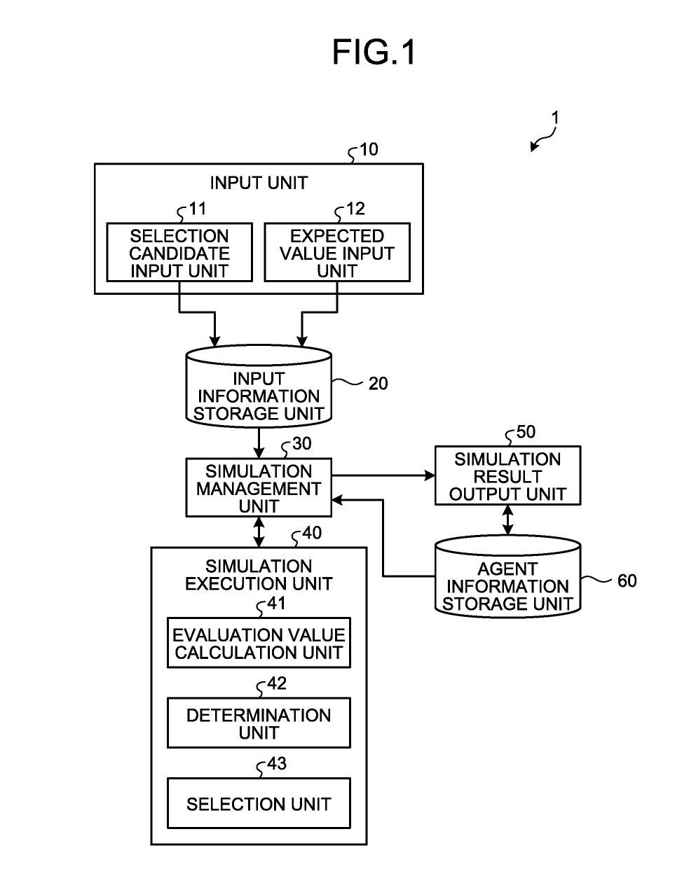

FIG. 1 is a block diagram illustrating an example of the functional configuration of the simulation apparatus 1 according to the first embodiment. The simulation apparatus 1 is an information processing device such as a personal computer (PC). The simulation apparatus 1 executes a simulation program (hereinafter, simply referred to as a program) based on input information, for example, a plurality of stores as the selection candidates and an expected value of each store to simulate the selection behavior of the consumer. At that time, the simulation apparatus 1 functions as a so-called agent that performs a series of simulation processes instead of the user. In addition, the simulation apparatus 1 has a multi-agent function that simulates the selection behavior of selecting items belonging to a plurality of different categories in parallel.

As illustrated in FIG. 1, the simulation apparatus 1 includes an input unit 10, an input information storage unit 20, a simulation management unit 30, a simulation execution unit 40, a simulation result output unit 50, and an agent information storage unit 60.

The input unit 10 transmits various kinds of information for simulations, which will be described below, from an input device, such as a mouse or a keyboard, to the simulation management unit 30 and the simulation execution unit 40. In addition, the input unit 10 includes a selection candidate input unit 11 and an expected value input unit 12. The selection candidate input unit 11 sets a plurality of stores as the selection candidate based on the operation of the input device. The expected value input unit 12 sets an expected value indicating the level of satisfaction expected for each of the set stores, based on the operation of the input device.

The input information storage unit 20 stores information, such as each store and the expected values, input from the input unit 10 in a storage device such as a random access memory (RAM) or a hard disk drive (HDD).

The simulation management unit 30 manages a consumer selection behavior simulation process performed by the simulation execution unit 40 which will be described below. The simulation management unit 30 reads the input information stored in the input information storage unit 20 and the interim report of the simulation (an evaluation value of each store) stored in the agent information storage unit 60 according to the progress of the simulation performed by the simulation execution unit 40. In addition, the simulation management unit 30 outputs the read content to the simulation execution unit 40. In addition, the simulation management unit 30 outputs the results of the sequential simulation for the behavior of the consumer by the simulation execution unit 40 to the simulation result output unit 50.

The simulation execution unit 40 sequentially simulates the evaluation values when the consumer actually visits each store. In addition, the simulation execution unit 40 determines the next behavior of the consumer based on the expected value and the evaluation value. Specifically, the simulation execution unit 40 determines whether the consumer confirms an unconfirmed store or selects one store from the confirmed stores. Then, the simulation execution unit 40 outputs the simulation results to the simulation management unit 30.

The simulation execution unit 40 includes an evaluation value calculation unit 41, a determination unit 42, and a selection unit 43. The evaluation value calculation unit 41 calculates the evaluation value. The evaluation value calculation unit 41 is an example of a confirmation unit. The determination unit 42 determines whether to continue or end the confirmation, based on whether the confirmation has been performed for all of the stores. The determination unit 42 compares the expected value of an unconfirmed store with the evaluation value of a confirmed store to determine whether to continue or end the confirmation. The determination unit 42 is an example of a determination unit. The selection unit 43 compares the evaluation values of each store calculated by the evaluation value calculation unit 41 to determine the store to be selected. The selection unit 43 is an example of a selection unit. The functions of each unit will be described in detail below.

The simulation result output unit 50 stores the evaluation values of each store, which are the results of the sequential simulation for the behavior of the consumer, in the agent information storage unit 60. In addition, the simulation result output unit 50 displays, for example, the evaluation values stored in the agent information storage unit 60 on a display device such as a monitor. Alternatively, the simulation result output unit 50 outputs, for example, the evaluation values stored in the agent information storage unit 60 to a printing device, such as a printer, so as to be printed. In addition, the simulation results may be sequentially output or the simulation results collected for a predetermined period of time may be output.

The agent information storage unit 60 stores, for example, the evaluation values of each store obtained by the simulation in a storage device such as a RAM or an HDD.

Flow of Process Performed by Simulation Apparatus

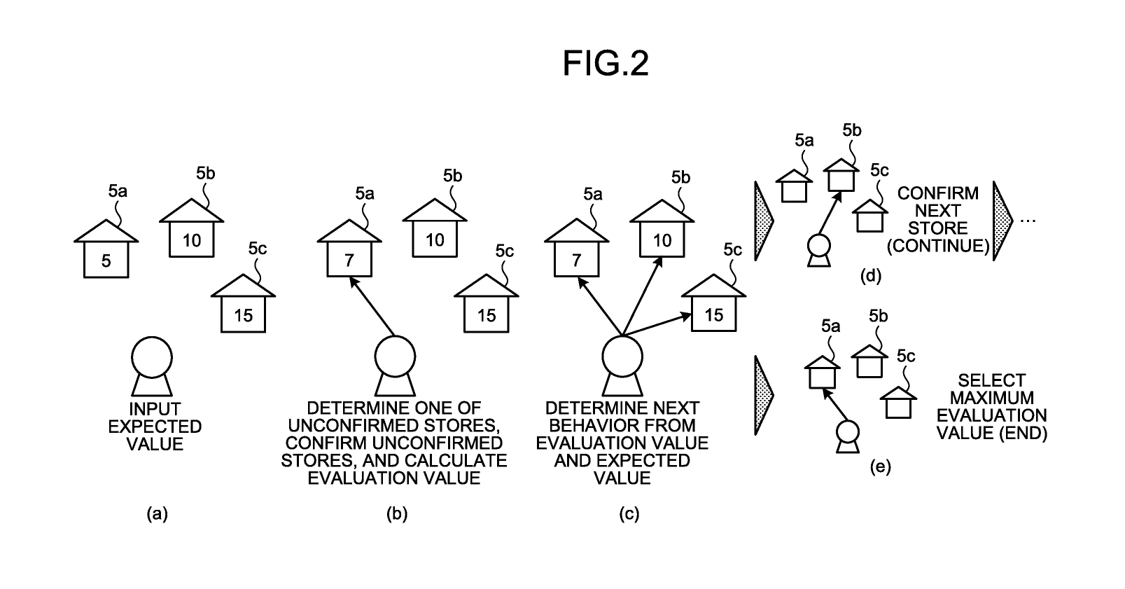

Next, an example of the flow of a detailed process performed by the simulation apparatus 1 will be described. FIG. 2 is a diagram illustrating an example of the flow of the process performed by the simulation apparatus 1.

First, as illustrated in FIG. 2(a), the expected values are input to the stores 5a, 5b, and 5c. A larger expected value indicates higher expectations. In the example illustrated in FIG. 2(a), an expected value (5) is input to the store 5a. In addition, an expected value (10) is input to the store 5b and an expected value (15) is input to the store 5c. The term “expected value” is a value indicating the level of consumer satisfaction expected for each store. As the expected value increases, the expected level of satisfaction increases. The expected value is input based on, for example, the past purchase history of the consumer, the hobby and taste of the consumer, and general information. For example, in a case in which the evaluation value of the store visited in the past is high, the expected values of the store and stores belonging to the same category as the store are set to a high value. In addition, the expected value of a store which handles brand items that the consumer likes is set to a high value. Furthermore, the expected value of the store that is highly rated by the consumers is set to a high value. In the actual simulation, a variance of the expected values is set at the same time as the expected values. However, here, the description will be made using only the expected values. The variance of the expected values will be described below.

In a case in which the simulation starts, the simulation apparatus 1 confirms an unconfirmed store among the plurality of stores 5a, 5b, and 5c and calculates the evaluation value of the store. The term “confirmation” means confirming an item in the store and evaluating the level of consumer satisfaction for the store. FIG. 2(b) illustrates a case in which the confirmation is performed for the store 5a and an evaluation value (7) is obtained. In this case, since the evaluation value (7) is greater than the set expected value (5), the evaluation value (7) is stored so as to be associated with the store 5a. That is, this indicates that the store 5a is actually visited and the expected value of the store 5a is greater than the set expected value.

Then, the simulation apparatus 1 selects the next store to visit. The selection is performed based on the evaluation value of the confirmed store and the expected value of the unconfirmed store. In the example illustrated in FIG. 2(c), the simulation apparatus 1 compares the evaluation value (7) of the store 5a, the expected value (10) of the store 5b, and the expected value (15) of the store 5c. Then, the simulation apparatus 1 determines to continuously perform the confirmation for the store 5b or the store 5c having the expected value greater than the evaluation value (7) of the store 5a based on the comparison result. Which of the stores 5b and 5c is confirmed first may be appropriately determined based on, for example, the distance to each store and the magnitude relationship between the expected values of the stores. In the step illustrated in FIG. 2(c), in a case in which the evaluation value of the store 5a is greater than the expected values of the unconfirmed stores 5b and 5c, it may be determined in this step whether to end the confirmation.

In a case in which it is determined in the step illustrated in FIG. 2(c) that the next store 5b is confirmed, the process proceeds to a step illustrated in FIG. 2(d) and a new store is confirmed.

On the other hand, in a case in which it is determined in the step illustrated in FIG. 2(c) that the confirmation ends, the process proceeds to a step illustrated in FIG. 2(e), one selection candidate is selected, and the simulation ends. In this case, for example, the store (for example, the store 5a) with the highest evaluation value is selected. In a case in which it is determined in the step illustrated in FIG. 2(c) that the confirmation for all of the stores 5a, 5b, and 5c has ended, the process proceeds to the step illustrated in FIG. 2(e), without condition, and the simulation ends.

Effect of Process Performed by Simulation Apparatus

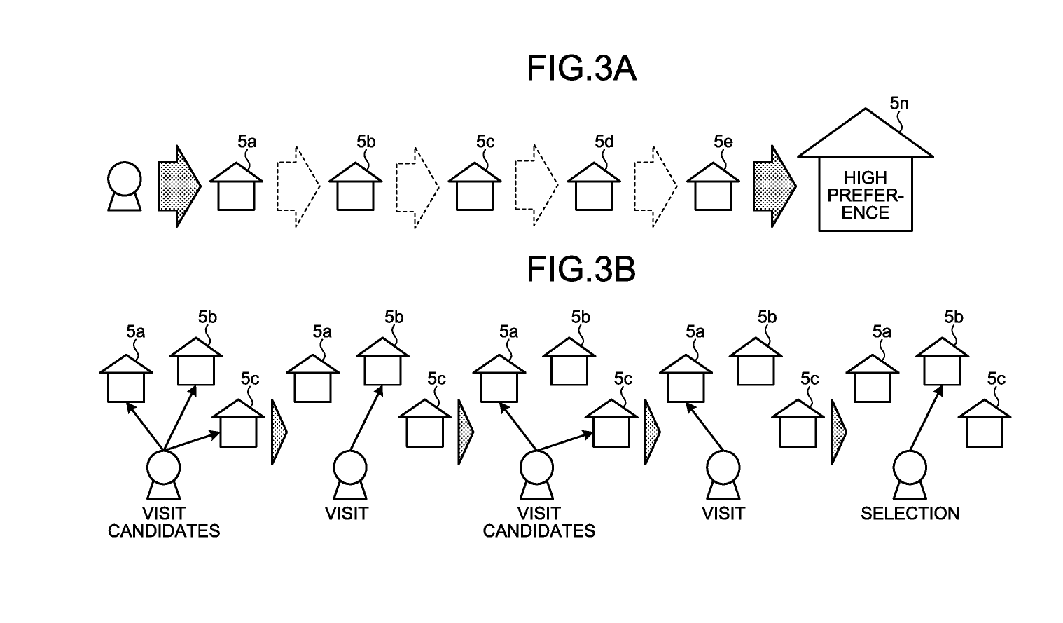

Next, the effect of the simulation apparatus 1 will be described with reference to FIGS. 3A and 3B. FIGS. 3A and 3B are diagrams illustrating the effect of the simulation apparatus 1. First, the simulation apparatus 1 sets the expected values to the stores 5a, 5b, 5c, 5d, 5e, and 5n. Then, the simulation apparatus 1 compares the evaluation value of a confirmed selection candidate and the expected value of an unconfirmed store to determine whether to end or continue the selection process. Therefore, it is possible to prevent the influence of a store evaluation order. In a case in which the store 5n has a sufficiently large expected value (high preference) and the store 5n is finally visited as illustrated in FIG. 3A, the selection process does not end before the store 5n is visited.

Since the simulation apparatus 1 calculates the evaluation value different from the expected value of each store, final selection is not determined in advance. Therefore, it is possible to reproduce the behavior of returning to the previously confirmed store and selecting the store. For example, as illustrated in FIG. 3B, the consumer can visit all of the stores 5a, 5b, and 5c as the selection candidates and select a store (for example, the store 5b) with the maximum evaluation value from the evaluated stores 5a, 5b, and 5c.

Operation of First Embodiment

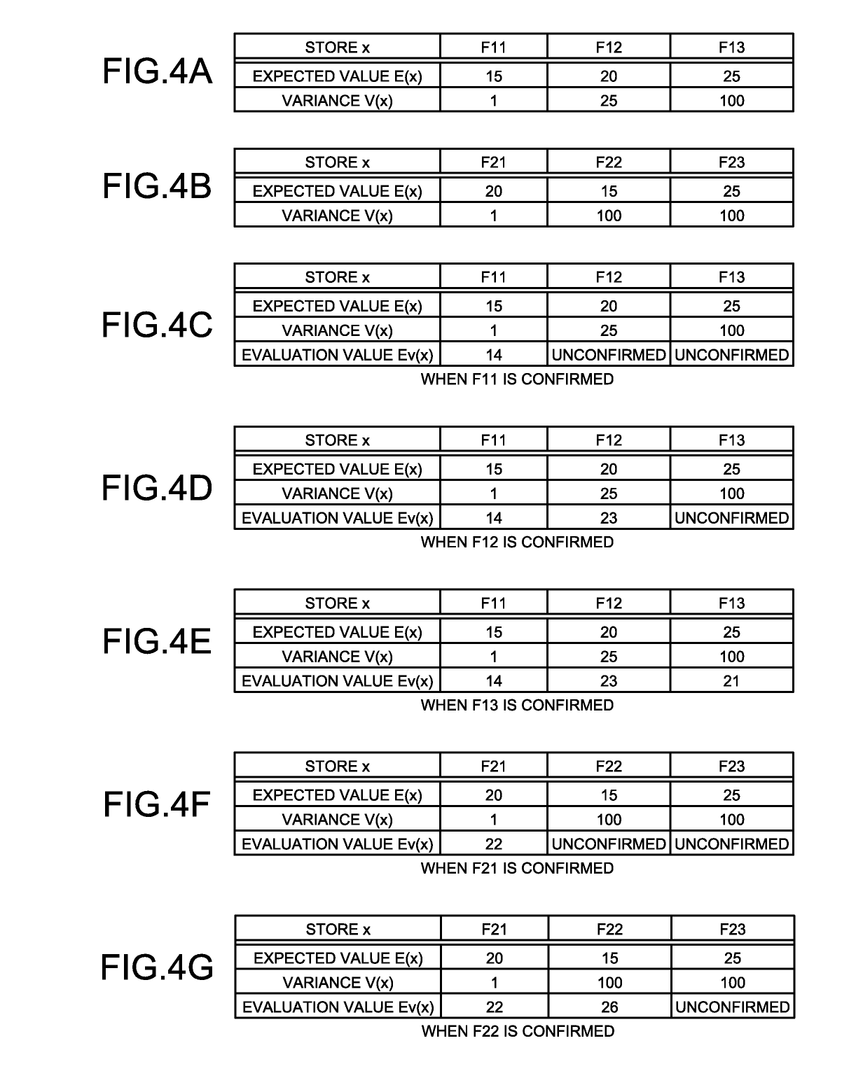

Next, an example of the operation of the simulation apparatus 1 according to the first embodiment will be described with reference to FIGS. 4A to 4G. FIGS. 4A to 4G are diagrams illustrating the content of the process performed by the simulation apparatus 1 according to the first embodiment.

FIG. 4A illustrates an example of an expected value E(x) and a variance V(x) preset to each of a plurality of stores x (x=F11, F12, and F13) that sell items belonging to a category K1, for example, bags. Information for specifying the stores F11, F12, and F13 is input by the selection candidate input unit 11. The expected value E(x) and the variance V(x) are input by the expected value input unit 12. As described above, the expected value E(x) indicates the level of satisfaction expected for the store x (x=F11, F12, and F13). In addition, the variance V(x) indicates the magnitude of a variation in the expected value E(x). The variance V(x) is set by, for example, the past experience of the consumer. For example, for the store x that the consumer knows, it is considered that a variation in the expected value of the consumer for the store x is small. Therefore, a small value is set to the variance V(x). In contrast, for the store x that the consumer visits first, since the consumer does not have detailed information about the store x, a variation in the expected value is large. Therefore, a large value is set to the variance V(x). In addition, the variance V(x) may be set based on general characteristics of the store x as the selection candidate. For example, a smaller variance V(x) is set to the store x having a larger number of items belonging to the category to be selected. In addition, a larger variance V(x) is set to the store x in which there is a larger variation in the amount of stock or the selling price of an item is more frequently changed by, for example, a limited-time sale.

Similarly, FIG. 4B illustrates an example of a plurality of stores F21, F22, and F23 which sell items belonging to a category K2, for example, cosmetics and an expected value E(x) and a variance V(x) which are preset to each of the stores F21, F22, and F23.

The simulation management unit 30 and the simulation execution unit 40 (FIG. 2) independently perform a selection behavior simulation for a plurality of categories (the category K1 and the category K2). At that time, the simulation apparatus 1 simulates a selection behavior for the category K1 and a selection behavior for the category K2 such that the selection behaviors are not affected by each other.

Next, the simulation of the selection behavior for items belonging to the category K1 will be described with reference to FIGS. 4C to 4E. First, the simulation management unit 30 directs the simulation execution unit 40 to perform confirmation for the store F11. In this case, the evaluation value calculation unit 41 assumes that the expected value E(F11) of the store F11 has a normal distribution with a mean of 15 and a variance of 1 based on the expected value E(F11)=15 and the variance V(F11)=1 for the store F11, with reference to the information illustrated in FIG. 4A. Then, the evaluation value calculation unit 41 calculates the evaluation value Ev(F11)=14 for the store F11. For example, the evaluation value Ev(x) may be probabilistically calculated based on the normal distribution based on the expected value E(x) and the variance V(x) set in FIG. 4A.

The determination unit 42 compares the calculated evaluation value Ev(F11) with each of the expected value E(F12) of the unconfirmed store F12 and the expected value E(F13) of the unconfirmed store F13. As a result, since Ev(F11)<E(F12) and Ev(F11)<E(F13) are satisfied, the determination unit 42 determines that the evaluation value Ev(x) greater than the evaluation value Ev(F11) is likely to be obtained and determines to continue the confirmation.

Then, the simulation management unit 30 directs the simulation execution unit 40 to perform confirmation for the store F12. The evaluation value calculation unit 41 assumes that the expected value E(F12) of the store F12 has a normal distribution with a mean of 20 and a variance of 25 based on the expected value E(F12)=20 and the variance V(F12)=25 for the store F12, with reference to the information illustrated in FIG. 4A. Then, the evaluation value calculation unit 41 calculates the evaluation value Ev(F12)=23 for the store F12 as illustrated in FIG. 4D.

The determination unit 42 compares the calculated evaluation value Ev(F12) with the expected value E(F13) of the unconfirmed store F13. As a result, since Ev(F12)<E(F13) is satisfied, the determination unit 42 determines that the evaluation value Ev(F13) greater than the evaluation value Ev(F12) is likely to be obtained and determines to continue the confirmation for an unconfirmed store x.

Then, the simulation management unit 30 directs the simulation execution unit 40 to perform confirmation for the store F13. The evaluation value calculation unit 41 assumes that the expected value E(F13) of the store F13 has a normal distribution with a mean of 25 and a variance of 100 based on the expected value E(F13)=25 and the variance V(F13)=100 for the store F13, with reference to the information illustrated in FIG. 4A. Then, the evaluation value calculation unit 41 calculates the evaluation value Ev(F13)=21 for the store F13 as illustrated in FIG. 4E.

Since confirmation for all of the stores F11, F12, and F13 has ended, the selection unit 43 compares all of the calculated evaluation values Ev(F11), Ev(F12), and Ev(F13). Then, the selection unit 43 determines the store F12 with the maximum evaluation value Ev(F12) as the selection candidate. As such, according to the example illustrated in FIGS. 4A to 4E, since the evaluation value Ev(F13) of the store F13 is less than the set evaluation value, the simulation apparatus 1 can reproduce a behavior of returning to the store F12 confirmed in the past and deciding the selection candidate.

Next, the simulation of the selection behavior for items belonging to the category K2 will be described with reference to FIGS. 4F and 4G. First, the simulation management unit 30 directs the simulation execution unit 40 to perform confirmation for the store F21. In this case, the evaluation value calculation unit 41 assumes that the expected value E(F21) of the store F21 has a normal distribution with a mean of 20 and a variance of 1 based on the expected value E(F21)=20 and the variance V(F21)=1 for the store F21, with reference to the information illustrated in FIG. 4F. Then, the evaluation value calculation unit 41 calculates the evaluation value Ev(F21)=22 for the store F21.

The determination unit 42 compares the calculated evaluation value Ev(F21) with each of the expected value E(F22) of the unconfirmed store F22 and the expected value E(F23) of the unconfirmed store F23. As a result, since Ev(F21)<E(F23) is satisfied, the determination unit 42 determines that the evaluation value Ev(x) greater than the evaluation value Ev(F21) is likely to be obtained and determines to continue the confirmation.

Then, the simulation management unit 30 directs the simulation execution unit 40 to perform confirmation for the store F22. The evaluation value calculation unit 41 assumes that the expected value E(F22) of the store F22 has a normal distribution with a mean of 15 and a variance of 100 based on the expected value E(F22)=15 and the variance V(F22)=100 for the store F22, with reference to the information illustrated in FIG. 4F. Then, the evaluation value calculation unit 41 calculates the evaluation value Ev(F22)=26 for the store F22 as illustrated in FIG. 4G.

The determination unit 42 compares the calculated evaluation value Ev(F22) with the expected value E(F23) of the unconfirmed store F23. As a result, since Ev(F22)>E(F23) is satisfied, the determination unit 42 determines not to perform confirmation for the store F23. Then, the selection unit 43 selects the store F22 with the maximum evaluation value as the selection candidate. As such, according to the example illustrated in FIGS. 4F and 4G, it is possible to reproduce a behavior of interrupting confirmation and deciding the selection candidate.

The simulation apparatus 1 independently simulates a selection behavior for items belonging to the category K1 and a selection behavior for items belonging to the category K2. Therefore, the simulation apparatus 1 interrupts confirmation for the store x at different times for items belonging to each category.

Flow of Process in First Embodiment

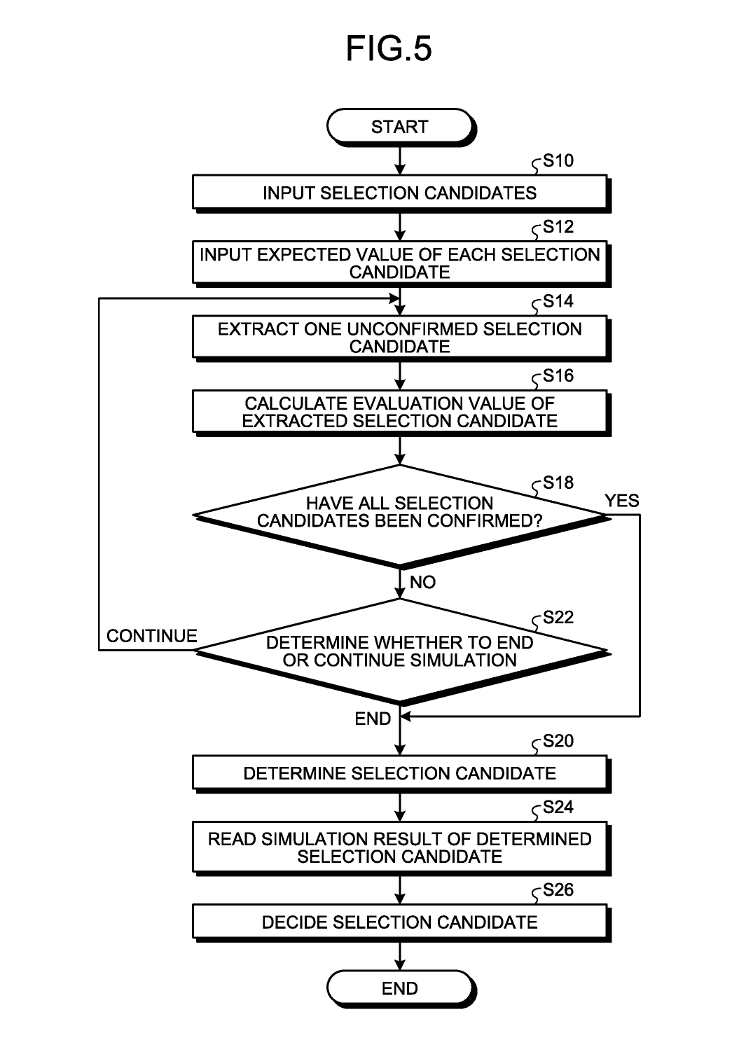

Next, the flow of the process performed by the execution of a program by the simulation apparatus 1 in the first embodiment will be described with reference to FIG. 5. FIG. 5 is a flowchart illustrating the flow of the process performed by the simulation apparatus 1 according to the first embodiment.

The stores x (x=F11, F12, F13) as the selection candidates are input by the operation of the selection candidate input unit 11 (Step S10). The input information is stored in the input information storage unit 20.

Then, the expected values E(x) of each store x are input by the operation of the expected value input unit 12 (Step S12). The variance V(x) of the expected values E(x) of each store x are similarly input, which is not described in the flowchart illustrated in FIG. 5. The input information is stored in the input information storage unit 20.

The simulation management unit 30 extracts one unconfirmed store x from the stores x which are the selection candidates (Step S14).

The evaluation value calculation unit 41 performs confirmation for the store x (selection candidate) extracted in Step S14 and calculates the evaluation value Ev(x) (Step S16). The calculated evaluation value Ev(x) is output to the simulation result output unit 50 and is stored in the agent information storage unit 60.

The determination unit 42 determines whether confirmation has been performed for all of the stores x (selection candidates) (Step S18). In a case in which the determination unit 42 determines that confirmation has been performed for all of the stores x (Step S18: Yes), the process proceeds to Step S20. On the other hand, in a case in which the determination unit 42 determines that confirmation has not been performed for all of the stores x (Step S18: No), the process proceeds to Step S22.

In a case in which the determination unit 42 determines in Step S18 that confirmation has been performed for all of the stores x (Step S18: Yes), the selection unit 43 determines a store x as a final selection candidate based on the evaluation values Ev(x) of the confirmed stores x (Step S20).

Then, the simulation management unit 30 reads the simulation result of the determined store x (selection candidate) from the agent information storage unit 60 (Step S24).

In addition, the simulation management unit 30 decides the store x as the selection candidate (Step S26). The decision result is output to the simulation result output unit 50 and is stored in the agent information storage unit 60 (not illustrated). Then the process illustrated in FIG. 5 ends.

In a case in which the determination unit 42 determines in Step S18 that confirmation has not been performed for all of the stores x (Step S18: No), the determination unit 42 determines whether to end or continue the simulation (Step S22). In a case in which the determination unit 42 determines to end the simulation, the process proceeds to Step S20. On the other hand, in a case in which the determination unit 42 determines to continue the simulation, the process proceeds to Step S14.

The simulation apparatus 1 has a multi-agent function and simulates the selection behaviors for items belonging to a plurality of categories K1, K2, . . . at the same time, which is not illustrated in the flowchart of FIG. 5.

As described above, the simulation apparatus 1 according to the first embodiment executes the program to direct the agent to perform confirmation for a plurality of stores x (selection candidates), using the expected values E(x) preset to each of the plurality of stores x. Then, the simulation apparatus 1 executes the program to direct the agent to perform a process of calculating the evaluation value Ev(x) of the store x. In addition, the simulation apparatus 1 executes the program to direct the agent to perform a process of determining whether to continue or end the process of confirming the store x based on the evaluation value Ev(x) of the confirmed store x and the expected value E(x) of the unconfirmed store x. In addition, in a case in which it is determined by the determination process performed by the execution of the program that the confirmation process ends, the simulation apparatus 1 directs the agent to perform a process of selecting one store x based on the evaluation value Ev(x) of the confirmed store x. Therefore, it is possible to dynamically change the selection behavior of the user based on the evaluation value Ev(x) of the confirmed store x and the expected value E(x) of the unconfirmed store x.

The simulation apparatus 1 according to the first embodiment executes the program to direct the agent to confirm the store x and calculate the evaluation value Ev(x) based on the expected value E(x) of the store x and the variance V(x) of the expected value E(x). Therefore, for example, it is possible to probabilistically calculate the evaluation value Ev(x) from the normal distribution with the average value E(x) and the variance V(x). In addition, a value based on, for example, the consumer's past experience can be set as the variance V(x). Therefore, it is possible to calculate the evaluation value Ev(x) close to the actual value.

### [b] Second Embodiment

Next, a second embodiment will be described. The second embodiment is an example in which restriction conditions related to the selection behavior are imposed when the selection behavior described in the first embodiment is performed. In particular, the second embodiment is an example in which a time restriction is imposed as the restriction conditions when the selection behavior is simulated. Specifically, the second embodiment is an example in which an upper limit time for selecting an unconfirmed store (selection candidate) is set and a store is determined within the upper limit time.

Configuration of Second Embodiment

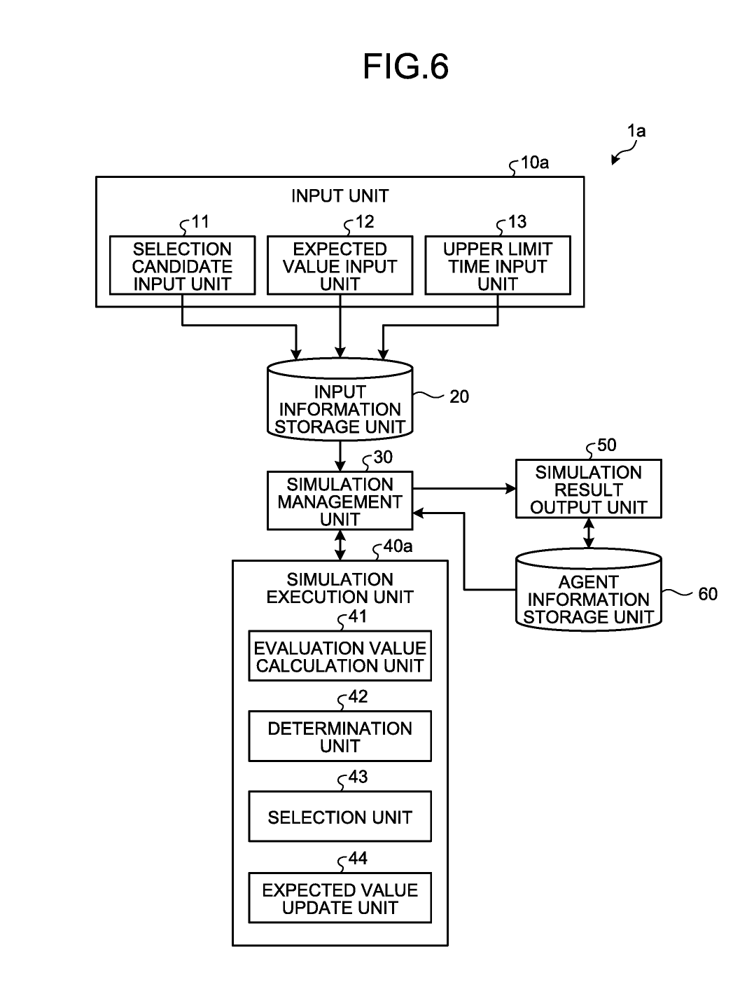

FIG. 6 is a block diagram illustrating an example of the functional configuration of a simulation apparatus 1a according to the second embodiment. The functional configuration of the simulation apparatus 1a is substantially the same as the functional configuration (FIG. 1) of the simulation apparatus 1 except that the simulation apparatus 1a includes an input unit 10a instead of the input unit 10. In addition, the simulation apparatus 1a includes a simulation execution unit 40a instead of the simulation execution unit 40. A simulation management unit 30 has a function of managing the remaining time for which the selection behavior can be performed, in addition to the functions described in the first embodiment.

The input unit 10a includes a selection candidate input unit 11, an expected value input unit 12, and an upper limit time input unit 13. Among them, the selection candidate input unit 11 and the expected value input unit 12 have the same functions as those in the first embodiment. The upper limit time input unit 13 sets the upper limit time for confirming an unconfirmed store (selection candidate). The simulation apparatus 1a imposes the restriction condition that the selection of the store x needs to end within, for example, two hours when the selection behavior of the consumer is simulated, using the information set by the upper limit time input unit 13.

The simulation execution unit 40a includes an evaluation value calculation unit 41, a determination unit 42, a selection unit 43, and an expected value update unit 44. Among them, the evaluation value calculation unit 41, the determination unit 42, and the selection unit 43 have the same functions as those in the first embodiment. The expected value update unit 44 updates the expected value E(x) of the unconfirmed store x based on the remaining time calculated from the upper limit time and the time for confirming the confirmed store x.

Operation of Second Embodiment

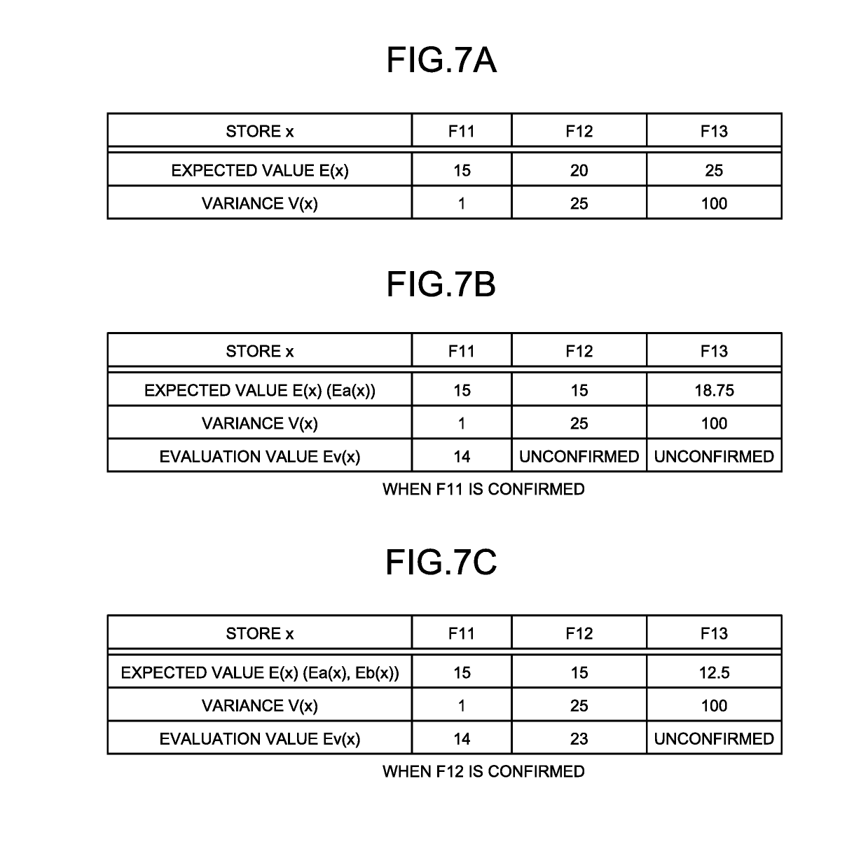

Next, an example of the operation of the simulation apparatus 1a according to the second embodiment will be described with reference to FIGS. 7A to 7C. FIGS. 7A to 7C are diagrams illustrating the content of a process performed by the simulation apparatus 1a according to the second embodiment.

FIG. 7A illustrates an example of an expected value E(x) and a variance V(x) preset for each of a plurality of stores x (x=F11, F12, and F13) that sell items belonging to a category K1, for example, bags. The content illustrated in FIG. 7A is the same as the content illustrated in FIG. 4A described in the first embodiment. In addition, it is assumed that the upper limit time for confirming an unconfirmed store x (selection candidate) is set to two hours when a simulation starts. In addition, it is assumed that, for example, it takes 30 minutes to confirm one store x and the remaining time is reduced by 30 minutes whenever one store x is confirmed.

First, the simulation management unit 30 directs the simulation execution unit 40a to perform confirmation for the store F11. The evaluation value calculation unit 41 calculates the evaluation value Ev(F11)=14 for the store F11 using the same method as that described in the first embodiment, with reference to the information illustrated in FIG. 7A, as illustrated in FIG. 7B.

Here, the expected value update unit 44 recalculates and updates the expected values E(F12) and E(F13) of the unconfirmed stores F12 and F13, assuming that it takes 30 minutes to confirm the store F11. Specifically, the expected value update unit 44 updates the expected value E(F12) to an expected value Ea(F12) using Expression (1). In addition, the expected value update unit 44 updates the expected value E(F13) to an expected value Ea(F13) using Expression (2).

Ea(F12)=E(F12)*(120−30)/120 (1)

Ea(F13)=E(F13)*(120−30)/120 (2)

As illustrated in FIG. 7B, the expected value E(F12) and the expected value E(F13) are updated to the expected value Ea(F12)=15 and the expected value Ea(F13)=18.75 by the update process, respectively. That is, the expected value update unit 44 updates the expected value E(x) to a small value with a reduction in the remaining time, which makes it difficult to select the unconfirmed store x.

The determination unit 42 compares the calculated evaluation value Ev(F11) with the expected value Ea(F12) of the unconfirmed store F12 and the expected value Ea(F13) of the unconfirmed store F13. As a result, since Ev(F11)<Ea(F12) and Ev(F11)<Ea(F13) are satisfied, the determination unit 42 determines that the evaluation values Ev(F12) and Ev(F13) greater than the evaluation value Ev(F11) are likely to be obtained and determines to continuously confirm the unconfirmed stores F12 and F13.

Then, the simulation management unit 30 directs the simulation execution unit 40a to perform confirmation for the store F12. The evaluation value calculation unit 41 assumes that the expected value Ea(F12) of the store F12 has a normal distribution with a mean of 15 and a variance of 25 based on the expected value Ea(F12)=15 and the variance V(F12)=25 for the store F12, with reference to the information illustrated in FIG. 7B. Then, the evaluation value calculation unit 41 calculates the evaluation value Ev(F12)=23 for the store F12 as illustrated in FIG. 7C.

Here, the expected value update unit 44 updates the expected value Ea(F13) of the unconfirmed store F13, assuming that it takes 30 minutes to confirm the store F12. Specifically, the expected value update unit 44 updates the expected value Ea(F13) to an expected value Eb(F13) using Expression (3).

Eb(F13)=E(F12)*(120−60)/120 (3)

In this way, the expected value Ea(F13)=18.75 is updated to the expected value Eb(F13)=12.5 (FIG. 7C).

The determination unit 42 compares the calculated evaluation value Ev(F12) with the expected value Eb(F13) of the unconfirmed store F13. As a result, since Ev(F12)>Eb(F13) is satisfied, the determination unit 42 determines not to confirm the store F13, that is, to end the simulation.

The selection unit 43 selects the store F12 with the highest evaluation value Ev(x) as the selection candidate. As such, according to the second embodiment, since the expected value E(x) is reduced with a reduction in the remaining time, it is possible to reproduce a selection behavior of rapidly determining the store x to be selected.

Flow of Process in Second Embodiment

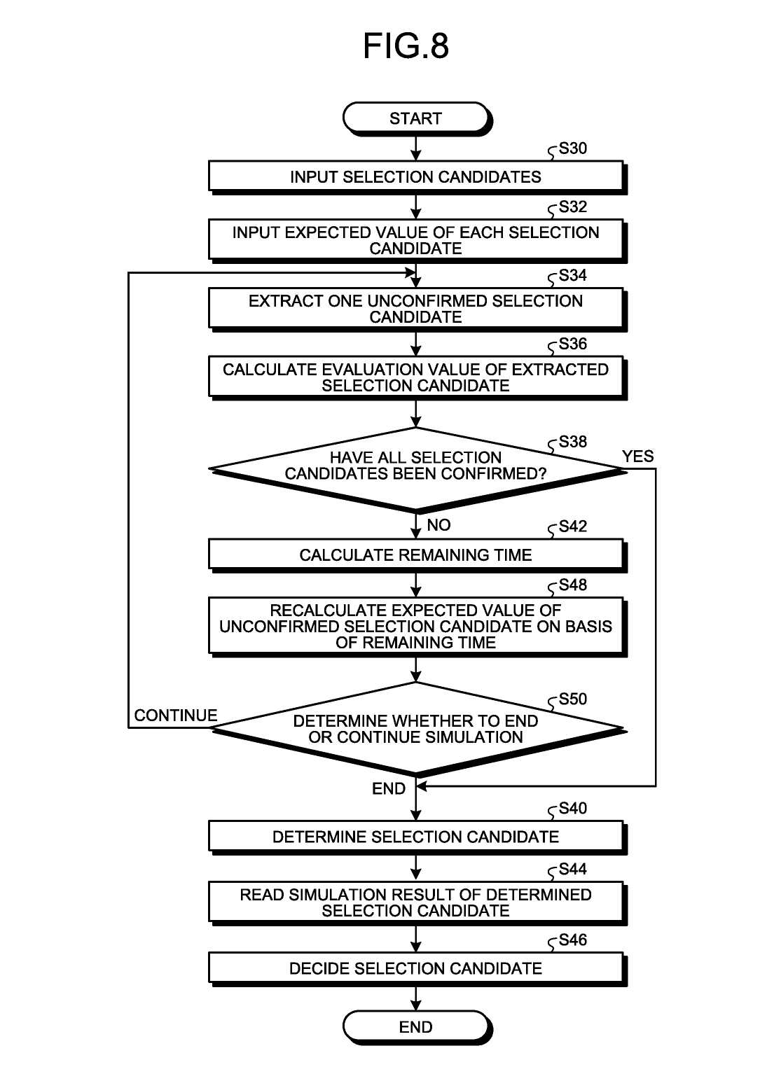

Next, the flow of a process performed by the execution of a program by the simulation apparatus 1a according to the second embodiment will be described with reference to FIG. 8. FIG. 8 is a flowchart illustrating the flow of the process performed by the simulation apparatus 1a according to the second embodiment.

The input (Step S30) of the store x (x=F11, F12, and F13) as the selection candidate by the simulation apparatus 1a and the input (Step S32) of the expected value E(x) of each store x by the simulation apparatus 1a are the same processes as those in Step S10 and Step S12 (FIG. 5) described in the first embodiment, respectively.

Then, the extraction (Step S34) of an unconfirmed store x from the stores x as the selection candidates by the simulation apparatus 1a and the calculation (Step S36) of the evaluation value Ev(x) of the extracted store x by the simulation apparatus 1a are the same processes as those in Step S14 and Step S16 (FIG. 5) described in the first embodiment, respectively.

Then, the determination unit 42 determines whether confirmation has been performed for all of the stores x (selection candidates) (Step S38). In a case in which the determination unit 42 determines that confirmation has been performed for all of the stores x (Step S38: Yes), the process proceeds to Step S40. On the other hand, in a case in which the determination unit 42 determines that confirmation has not been performed for all of the stores x (Step S38: No), the process proceeds to Step S42.

In a case in which the determination unit 42 determines in Step S38 that confirmation has been performed for all of the stores x in Step S38 (Step S38: Yes), the selection unit 43 determines a store x as a final selection candidate based on the evaluation values Ev(x) of the confirmed stores x (Step S40).

Then, the reading (Step S44) of the simulation result related to the determined store x by the simulation management unit 30 and the decision (Step S46) of the selection candidate by the simulation management unit 30 are the same processes as those in Step S24 and Step S26 (FIG. 5) described in the first embodiment, respectively.

In a case in which the determination unit 42 determines in Step S38 that confirmation has not been performed for all of the stores x (Step S38: No), the simulation management unit 30 calculates the remaining time for which the selection behavior can be continuously performed (Step S42).

Then, the expected value update unit 44 recalculates the expected value E(x) of an unconfirmed store x (selection candidate) based on the remaining time calculated in Step S42 and updates the expected value E(x) (Step S48).

Then, the determination unit 42 determines whether to end or continue the simulation (Step S50). In a case in which the determination unit 42 determines to end the simulation, the process proceeds to Step S40. On the other hand, in a case in which the determination unit 42 determines to continue the simulation, the process proceeds to Step S34.

As described above, the simulation apparatus 1a of the second embodiment executes the program to direct the agent to set the expected values E(x) of each of a plurality of stores x (selection candidates). In addition, the simulation apparatus 1a executes the program to direct the agent to calculate the remaining time based on the upper limit time for confirming the unconfirmed store x and the time for confirming the confirmed store x. Then, the simulation apparatus 1a executes the program to direct the agent to update the expected value E(x) of the unconfirmed store x based on the remaining time. Therefore, it is possible to simulate the selection behavior in a state in which restriction conditions are imposed. In particular, according to this aspect, the remaining time for which the selection behavior can be performed is set as the restriction conditions. Therefore, in a case in which the remaining time is short, the expected value E(x) of the unconfirmed store x is reduced according to the remaining time. As a result, it is possible to reproduce a selection behavior of rapidly determining the store x to be selected.

### [c] Third Embodiment

Next, a third embodiment will be described. The third embodiment is an example in which the degree of congestion of a store is used as restriction conditions when a selection behavior is simulated. Specifically, the third embodiment is an example in which the degree of congestion of the store is reflected in the simulation of the selection behavior to prevent a crowded store from being selected.

Configuration of Third Embodiment

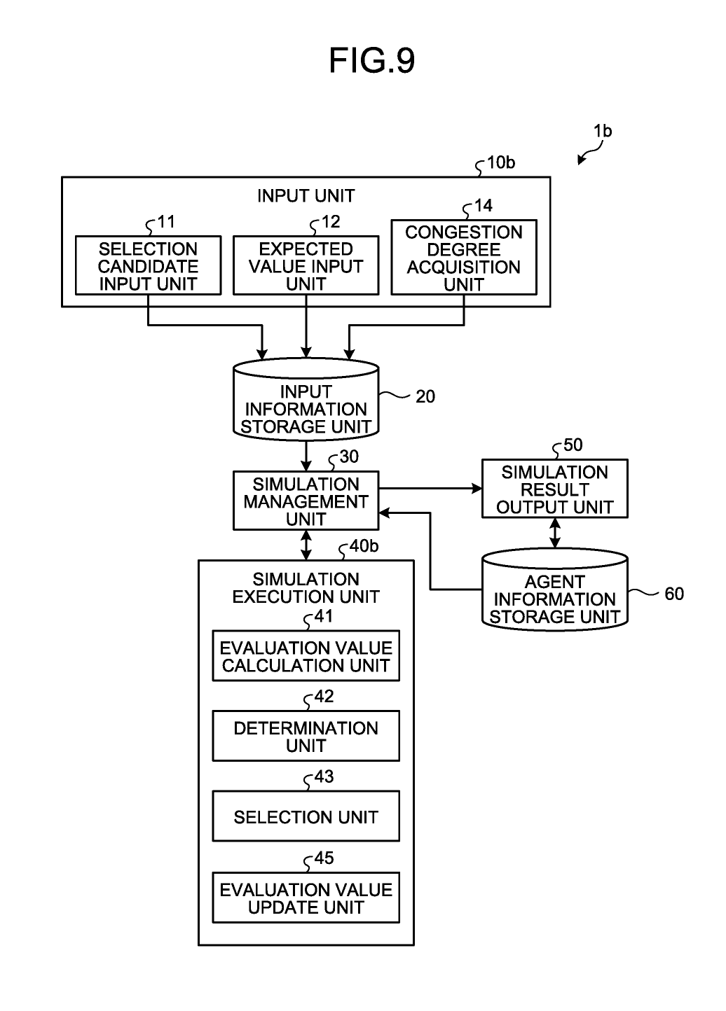

FIG. 9 is a block diagram illustrating an example of the functional configuration of a simulation apparatus 1b according to a third embodiment. The functional configuration of the simulation apparatus 1b is substantially the same as the functional configuration (FIG. 1) of the simulation apparatus 1 except that the simulation apparatus 1b includes an input unit 10b instead of the input unit 10. In addition, the simulation apparatus 1b includes a simulation execution unit 40b instead of the simulation execution unit 40.

The input unit 10b includes a selection candidate input unit 11, an expected value input unit 12, and a congestion degree acquisition unit 14. Among them, the selection candidate input unit 11 and the expected value input unit 12 have the same functions as those described in the first embodiment. The congestion degree acquisition unit 14 acquires the degree of congestion C(x) of a store x.

The degree of congestion C(x) is calculated, for example, based on the capacity (for example, a store area) of a target store x that is confirmed by an agent and the number of other agents that confirm the store x at the same time. That is, the congestion degree acquisition unit 14 considers that the degree of congestion of the store x increases as the number of other agents that confirm the store x increases and as the capacity of the store x is reduced.

The simulation execution unit 40b includes an evaluation value calculation unit 41, a determination unit 42, a selection unit 43, and an evaluation value update unit 45. Among them, the evaluation value calculation unit 41, the determination unit 42, and the selection unit 43 have the same functions as those described in the first embodiment. The evaluation value update unit 45 updates the evaluation value Ev(x) of the confirmed store x according to the degree of congestion C(x) of the store x. That is, in a case in which the degree of congestion C(x) is high, the evaluation value Ev(x) of the confirmed store x is reduced according to the degree of congestion. Therefore, the crowded store x is less likely to be selected.

Operation of Third Embodiment

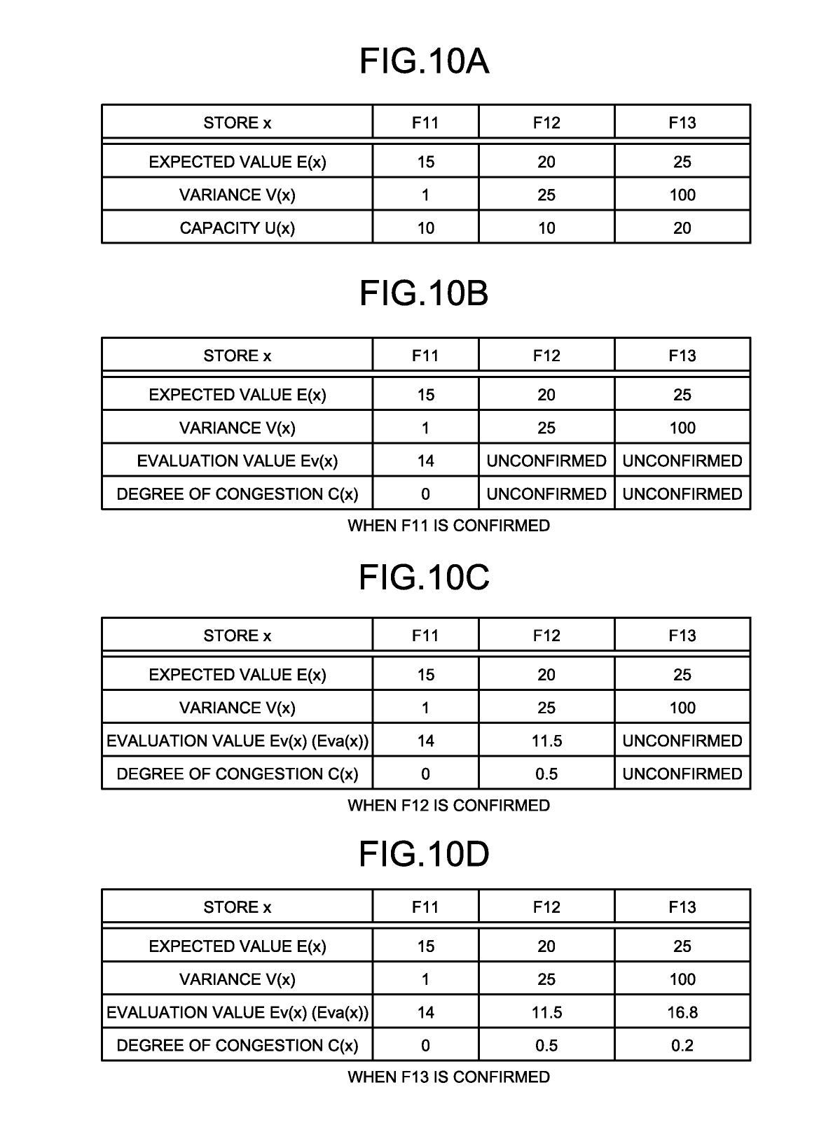

Next, an example of the operation of the simulation apparatus 1b according to the third embodiment will be described with reference to FIGS. 10A to 10D. FIGS. 10A to 10D are diagrams illustrating the content of a process performed by the simulation apparatus 1b according to the third embodiment.

FIG. 10A illustrates an example of an expected value E(x) and a variance V(x) preset to each of a plurality of stores x (x=F11, F12, and F13) that sell items belonging to a category K1, for example, bags. As illustrated in FIG. 10A, capacity U(x) corresponding to the size of the store x (for example, a store area) is set to each store x. The capacity U(x) is an index indicating the accommodation capacity of each store x.

In this embodiment, in a case in which confirmation is performed for each store x, the simulation apparatus 1b acquires the number of agents that perform confirmation for the same store x from the agent information storage unit 60. Then, the congestion degree acquisition unit 14 divides the acquired number of agents by the capacity U(x) and determines that the degree of congestion C(x) of the store x becomes higher as the calculation result becomes larger. The evaluation value update unit 45 recalculates the evaluation value Ev(x) obtained by performing confirmation for the store x based on the degree of congestion C(x) and updates the evaluation value Ev(x) to a new evaluation value Eva(x). The updated evaluation value Eva(x) is calculated by Expression (4).

Eva(x)=Ev(x)*(1−C(x)) (4)

First, the simulation management unit 30 directs the simulation execution unit 40b to perform confirmation for the store F11. The evaluation value calculation unit 41 calculates the evaluation value Ev(F11)=14 for the store F11 using the same method as that described in the first embodiment, with reference to the information illustrated in FIG. 10A, as illustrated in FIG. 10B.

It is assumed that the degree of congestion C(F11) of the store F11 acquired by the congestion degree acquisition unit 14 is 0. That is, it is assumed that the store F11 is not crowded. Therefore, the simulation management unit 30 uses the evaluation value Ev(F11)=14 calculated by the evaluation value calculation unit 41, without updating the evaluation value Ev(F11).

Then, the simulation management unit 30 directs the simulation execution unit 40b to perform confirmation for the store F12. The evaluation value calculation unit 41 assumes that the expected value E(F12) of the store F12 has a normal distribution with a mean of 20 and a variance of 25 based on the expected value E(F12)=20 and the variance V(F12)=25 for the store F12, with reference to the information illustrated in FIG. 10B. Then, the evaluation value calculation unit 41 calculates the evaluation value Ev(F12)=23 (not illustrated) for the store F12.

The congestion degree acquisition unit 14 acquires the degree of congestion C(F12) of the store F12. It is assumed that the degree of congestion C(F12) of the store F12 is 0.5 as illustrated in FIG. 10C. Therefore, As illustrated in FIG. 10C, the evaluation value update unit 45 updates the evaluation value Ev(F12)=23 for the store F12 to an evaluation value Eva(F12)=11.5 (23*(1-0.5)).

The determination unit 42 compares the calculated evaluation value Eva(F12)=11.5 with the expected value E(F13)=25 for the unconfirmed store F13. As a result, since Eva(F12)<E(F13) is satisfied, the determination unit 42 determines to continuously perform conformation for the unconfirmed store F13.

Then, the simulation management unit 30 directs the simulation execution unit 40b to perform confirmation for the store F13. The evaluation value calculation unit 41 assumes that the expected value E(F13) of the store F13 has a normal distribution with a mean of 25 and a variance of 100 based on the expected value E(F13)=25 and the variance V(F13)=100 for the store F13, with reference to the information illustrated in FIG. 10C. Then, the evaluation value calculation unit 41 calculates the evaluation value Ev(F13)=21 (not illustrated) for the store F13.

The congestion degree acquisition unit 14 acquires the degree of congestion C(F13) of the store F13. It is assumed that the degree of congestion C(F13) is 0.2 as illustrated in FIG. 10D. Therefore, As illustrated in FIG. 10D, the evaluation value update unit 45 updates the evaluation value Ev(F13)=21 for the store F13 to an evaluation value Eva(F13)=16.8 (21*(1−0.2)).

The determination unit 42 ends confirmation for each store x based on that conformation has been performed for all of the stores x. Then, the selection unit 43 compares the evaluation values Ev(x) (Eva(x)) of each store x and selects the store F13 with the maximum evaluation value Eva(x) as the selection candidate. As such, according to the third embodiment, it is possible to reproduce a selection behavior of avoiding a visit to the store F12 with a high degree of congestion C(x).

Flow of Process in Third Embodiment

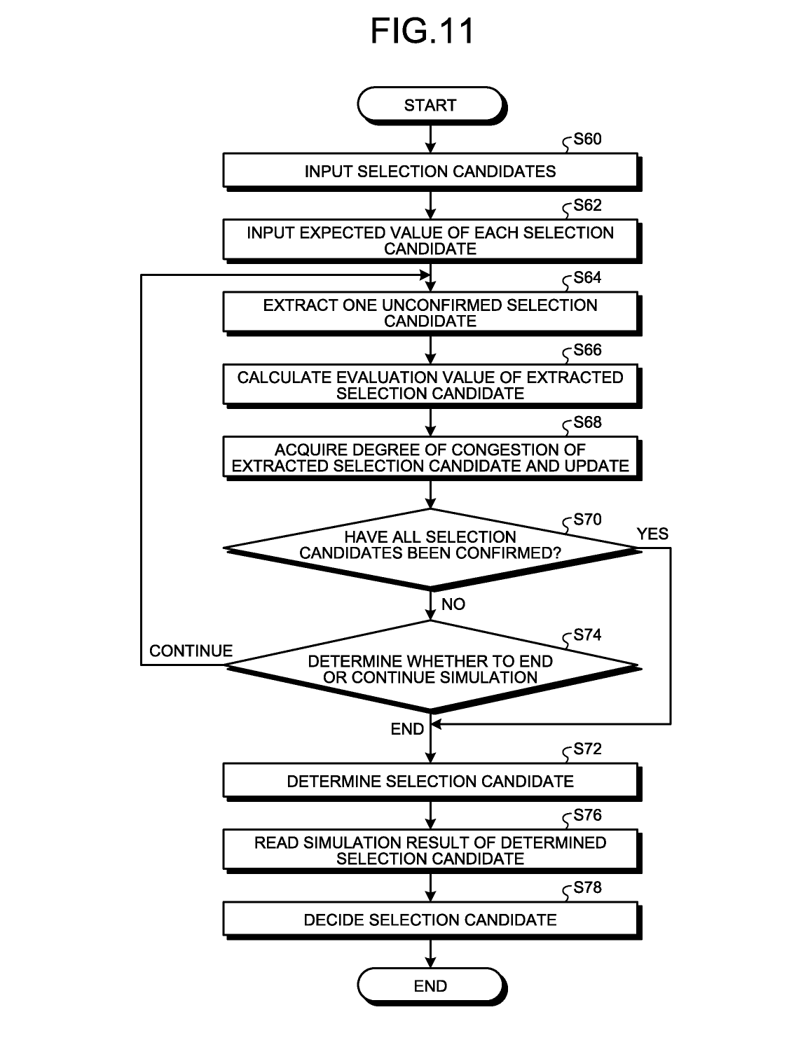

Next, the flow of a process performed by the execution of a program by the simulation apparatus 1b according to the third embodiment will be described with reference to FIG. 11. FIG. 11 is a flowchart illustrating the flow of the process performed by the simulation apparatus 1b according to the third embodiment.

The input (Step S60) of the store x (x=F11, F12, and F13) as the selection candidate by the simulation apparatus 1b and the input (Step S62) of the expected value E(x) of each store x by the simulation apparatus 1b are the same processes as those in Step S10 and Step S12 (FIG. 5) described in the first embodiment, respectively.

Then, the extraction (Step S64) of an unconfirmed store x from the stores x as the selection candidates by the simulation apparatus 1b and the calculation (Step S66) of the evaluation value Ev(x) of the extracted store x by the simulation apparatus 1b are the same processes as those in Step S14 and Step S16 (FIG. 5) described in the first embodiment, respectively.

Then, the congestion degree acquisition unit 14 acquires the degree of congestion C(x) of the store x extracted in Step S64. Then, the evaluation value update unit 45 updates the evaluation value Ev(x) of the store x based on the acquired degree of congestion C(x) (Step S68).

The determination unit 42 determines whether confirmation has been performed for all of the stores x (selection candidates) (Step S70). In a case in which the determination unit 42 determines that confirmation has been performed for all of the stores x (Step S70: Yes), the process proceeds to Step S72. On the other hand, in a case in which the determination unit 42 determines that confirmation has not been performed for all of the stores x (Step S70: No), the process proceeds to Step S74.

In a case in which the determination unit 42 determines in Step S70 that confirmation has been performed for all of the stores x (Step S70: Yes), the selection unit 43 determines a store x as a final selection candidate based on the evaluation values Ev(x) of the confirmed stores x (Step S72).

Then, the reading (Step S76) of the simulation result related to the determined store x by the simulation management unit 30 and the decision (Step S78) of the selection candidate by the simulation management unit 30 are the same processes as those in Step S24 and Step S26 (FIG. 5) described in the first embodiment, respectively.

In a case in which the determination unit 42 determines in Step S70 that confirmation has not been performed for all of the stores x (Step S70: No), the determination unit 42 determines whether to end or continue the simulation (Step S74). In a case in which the determination unit 42 determines to end the simulation, the process proceeds to Step S72. On the other hand, in a case in which the determination unit 42 determines to continue the simulation, the process proceeds Step S64.

As described above, the simulation apparatus 1b according to the third embodiment executes the program to direct the agent to set the degree of congestion C(x) of each of a plurality of stores x (selection candidates). In addition, the simulation apparatus 1b executes the program to direct the agent update the evaluation value E(x) of the confirmed store x based on the degree of congestion C(x). Therefore, it is possible to perform simulate a selection behavior in a state in which restriction conditions are imposed. In particular, according to this aspect, since the degree of congestion C(x) of the store x is set as the restriction conditions, it is possible to prevent a crowded store x from being selected. Therefore, it is possible to reproduce a selection behavior of avoiding a visit to the store F12 with a high degree of congestion C(x).

### [d] Fourth Embodiment

Next, a fourth embodiment will be described. The fourth embodiment is an example in which a distance between stores is used as the restriction conditions when a selection behavior is simulated. Specifically, the fourth embodiment is an example in which the distance between the stores is reflected in the simulation of a selection behavior to prevent a distant store from being selected.

Configuration of Fourth Embodiment

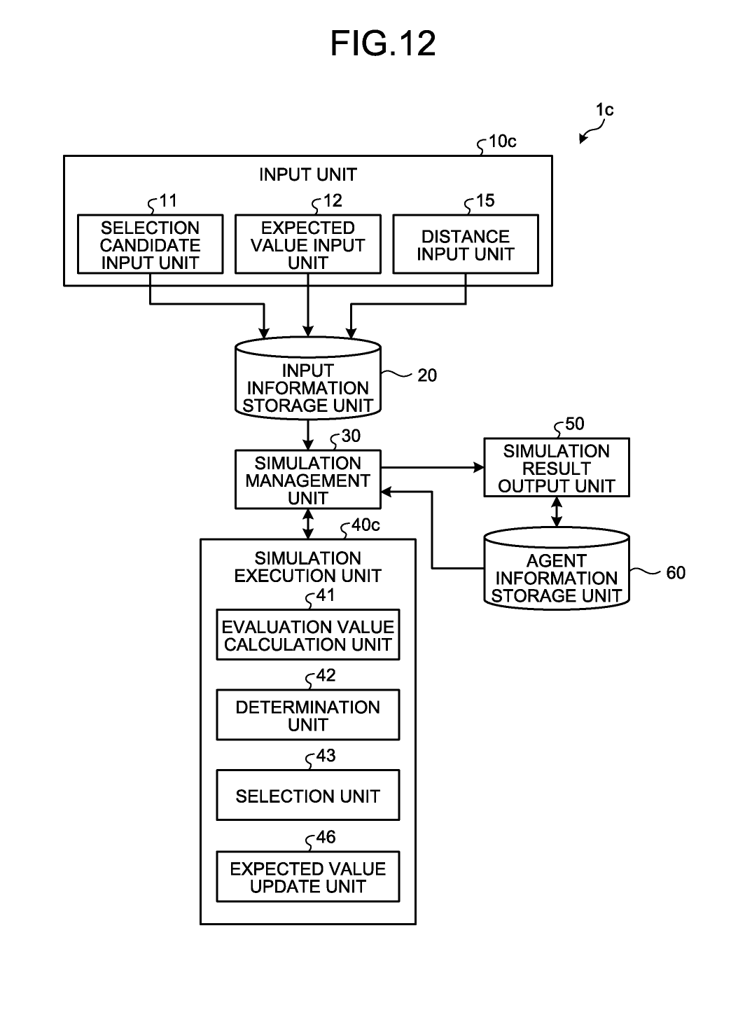

FIG. 12 is a block diagram illustrating an example of the functional configuration of a simulation apparatus 1c according to the fourth embodiment. The functional configuration of the simulation apparatus 1c is substantially the same as the functional configuration (FIG. 1) of the simulation apparatus 1 except that the simulation apparatus 1c includes an input unit 10c instead of the input unit 10. In addition, the simulation apparatus 1c includes a simulation execution unit 40c instead of the simulation execution unit 40.

The input unit 10c includes a selection candidate input unit 11, an expected value input unit 12, and a distance input unit 15. Among them, the selection candidate input unit 11 and the expected value input unit 12 have the same functions as those described in the first embodiment. The distance input unit 15 sets a distance between stores x as the selection candidates.

The simulation execution unit 40c includes an evaluation value calculation unit 41, a determination unit 42, a selection unit 43, and an expected value update unit 46. Among them, the evaluation value calculation unit 41, the determination unit 42, and the selection unit 43 have the same functions as those described in the first embodiment. The expected value update unit 46 updates the expected value E(x) of an unconfirmed store x based on the distance between the stores x. That is, the expected value E(x) of the unconfirmed store x is reduced as the distance to the unconfirmed store x increases. Therefore, a distant unconfirmed store x is less likely to be selected.

Operation of Fourth Embodiment

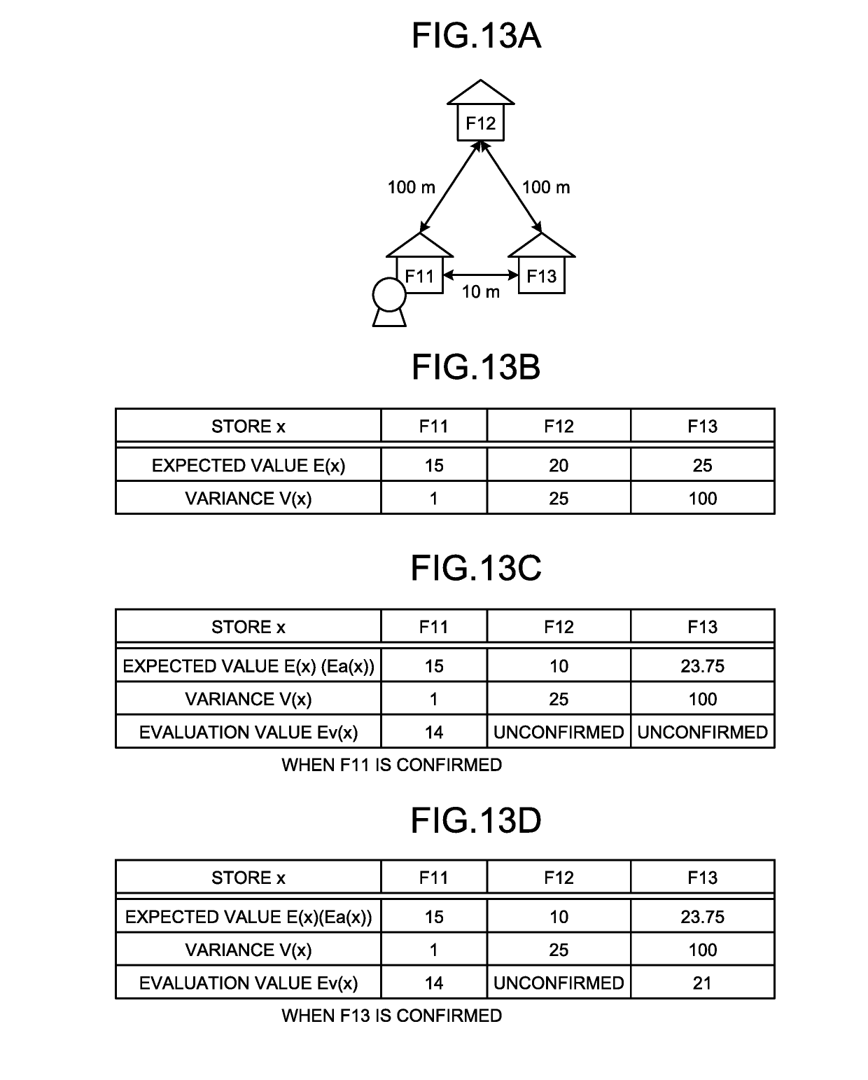

Next, an example of the operation of the simulation apparatus 1c according to the fourth embodiment will be described with reference to FIGS. 13A to 13D. FIGS. 13A to 13D are diagrams illustrating the content of the process performed by the simulation apparatus 1c according to the fourth embodiment.

FIG. 13A is a diagram illustrating a positional relationship between the stores x (x=F11, F12, and F13) as the selection candidates. FIG. 13A illustrates that the store F11 and the store F13 are close to each other and the store F12 is distant from the store F11 and the store F13.

FIG. 13B illustrates an example of an expected value E(x) and a variance V(x) preset for each of a plurality of stores x (x=F11, F12, and F13). FIG. 13B is the same as FIG. 4A described in the first embodiment. In the simulation performed by the simulation apparatus 1c, first, the initial position of the consumer that performs a selection behavior needs to be set. Here, it is assumed that the initial position of the consumer is the store F11.

First, the simulation management unit 30 directs the simulation execution unit 40c to perform confirmation for the store F11 which is the initial position of the agent. The evaluation value calculation unit 41 calculates the evaluation value Ev(F11)=14 for the store F11 using the same method as that described in the first embodiment, with reference to the information illustrated in FIG. 13B, as illustrated in FIG. 13C.

Here, the expected value update unit 46 recalculates and updates the expected values E(F12) and E(F13) of the unconfirmed stores F12 and F13. Specifically, the expected value update unit 46 updates the expected value E(F12) to an expected value Ea(F12) using Expression (5). In addition, the expected value update unit 46 updates the expected value E(F13) to an expected value Ea(F13) using Expression (6).

Ea(F12)=E(F12)*(200−100)/200 (5)

Ea(F13)=E(F13)*(200−10)/200 (6)

As illustrated in FIG. 13C, the expected value E(F12) and the expected value E(F13) are updated to the expected value Ea(F12)=10 and the expected value Ea(F13)=23.75 by the update process, respectively. As illustrated in Expression (5) and Expression (6), in this embodiment, in a case in which the distance between different stores x is 200 m, the expected value Ea(x) is updated to 0. In addition, it is assumed that the updated expected value Ea(x) is 0 in a case in which the distance between the stores x is greater than 200 m. That is, it is assumed that the simulation apparatus 1c does not select the store x that is 200 m or more away. The value of 200 m that is set as a reference distance here is illustrative and the reference distance may be appropriately set.

The determination unit 42 compares the calculated evaluation value Ev(F11) with the expected value Ea(F12) of the unconfirmed store F12 and the expected value Ea(F13) of the store F13. As a result, since Ev(F11)>Ea(F12) and Ev(F11)<Ea(F13) are satisfied, the determination unit 42 determines that the evaluation value Ev(F13) greater than the evaluation value Ev(F11) is likely to be obtained. Then, the determination unit 42 determines to skip confirmation for the unconfirmed store F12 and to perform confirmation for the unconfirmed store F13 first.

Then, the simulation management unit 30 directs the simulation execution unit 40c to perform confirmation for the store F13. The evaluation value calculation unit 41 assumes that the expected value Ea(F13) of the store F13 has a normal distribution with a mean of 23.75 and a variance of 100 based on the expected value Ea(F13)=23.75 and the variance V(F13)=100 for the store F13, with reference to the information illustrated in FIG. 13C. Then, the evaluation value calculation unit 41 calculates the evaluation value Ev(F13)=21 for the store F13 as illustrated in FIG. 13D.

The expected value update unit 46 recalculates and updates the expected value Ea(F12) of the unconfirmed store F12. In this embodiment, the distance (100 m) between the store F13 and the store F12 is equal to the distance between the store F11 and the store F12. Therefore, the expected value Ea(F12) of the store F12 is not updated and Ea(F12)=10 is maintained.

The determination unit 42 compares the calculated evaluation value Ev(F13)=21 with the expected value Ea(F12)=10 for the unconfirmed store F12. As a result, since Ev(F13)>Ea(F12) is satisfied, the determination unit 42 determines not to perform confirmation for the store F12, that is, to end the simulation.

The selection unit 43 selects the store F13 with the highest evaluation value Ev(x) as the selection candidate. As such, according to the fourth embodiment, the expected value E(x) is updated according to the distance between the stores x. Therefore, it is possible to reproduce a selection behavior of avoiding a visit to the distant store F12.

Flow of Process in Fourth Embodiment

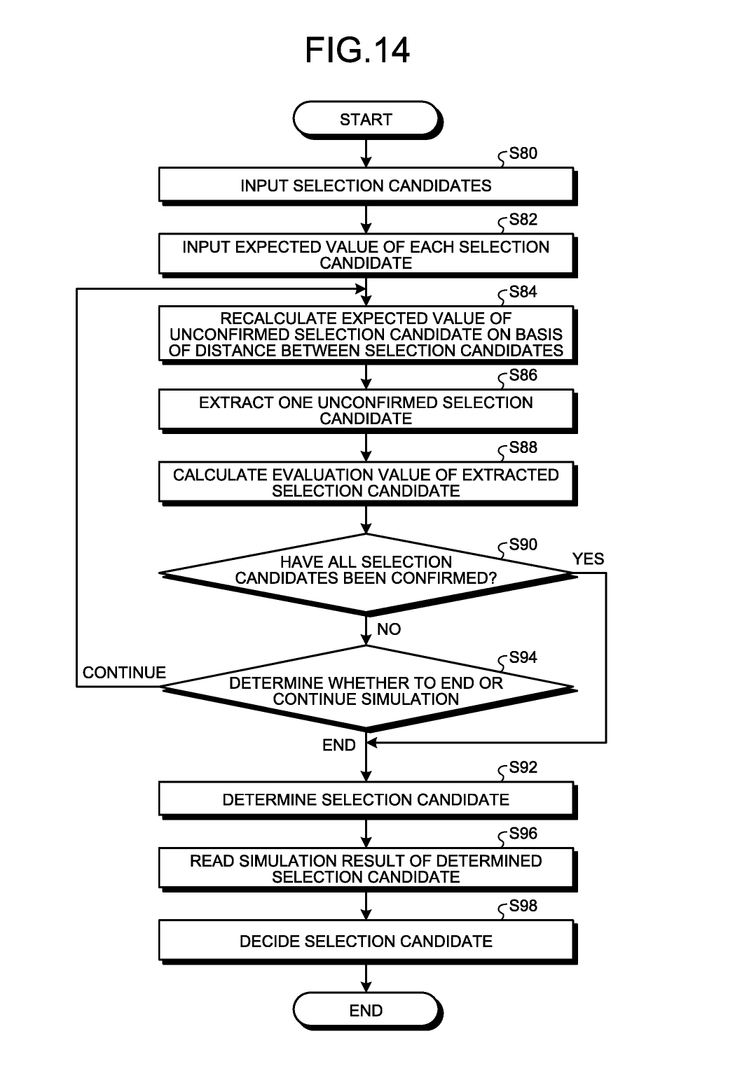

Next, the flow of a process performed by the execution of a program by the simulation apparatus 1c according to the fourth embodiment will be described with reference to FIG. 14. FIG. 14 is a flowchart illustrating the flow of the process performed by the simulation apparatus 1c according to the fourth embodiment.

The input (Step S80) of the store x (x=F11, F12, and F13) as the selection candidate by the simulation apparatus 1c and the input (Step S82) of the expected value E(x) of each store x by the simulation apparatus 1c are the same processes as those in Step S10 and Step S12 (FIG. 5) described in the first embodiment, respectively. In Step S80, the distance between the stores x is input by the operation of the distance input unit 15, which is not illustrated in the flowchart of FIG. 14.

Then, the expected value update unit 46 recalculates the expected value E(x) of an unconfirmed store x (selection candidate) based on the distance between the stores x and updates the expected value E(x) (Step S84).

Then, the extraction (Step S86) of an unconfirmed store x from the stores x as the selection candidates by the simulation apparatus 1c and the calculation (Step S88) of the evaluation value Ev(x) of the extracted store x by the simulation apparatus 1c are the same processes as those in Step S14 and Step S16 (FIG. 5) described in the first embodiment, respectively.

Then, the determination unit 42 determines whether confirmation has been performed for all of the stores x (selection candidates) (Step S90). In a case in which the determination unit 42 determines that confirmation has been performed for all of the stores x (Step S90: Yes), the process proceeds to Step S92. On the other hand, in a case in which the determination unit 42 determines that confirmation has not been performed for all of the stores x (Step S90: No), the process proceeds to Step S94.

In a case in which the determination unit 42 determines in Step S90 that confirmation has been performed for all of the stores x (Step S90: Yes), the selection unit 43 determines a store x as a final selection candidate based on the evaluation values Ev(x) of the confirmed stores x (Step S92).

Then, the reading (Step S96) of the simulation result related to the determined store x by the simulation management unit 30 and the decision (Step S98) of the selection candidate by the simulation management unit 30 are the same processes as those in Step S24 and Step S26 (FIG. 5) described in the first embodiment, respectively.

In a case in which the determination unit 42 determines in Step S90 that confirmation has not been performed for all of the stores x (Step S90: No), the determination unit 42 determines whether to end or continue the simulation (Step S94). In a case in which the determination unit 42 determines to end the simulation, the process proceeds to Step S92. On the other hand, in a case in which the determination unit 42 determines to continue the simulation, the process proceeds to Step S84.

As described above, the simulation apparatus 1c according to the fourth embodiment executes a program to direct the agent to set the distance between a plurality of stores x (selection candidates). In addition, the simulation apparatus 1c directs the agent to update the expected value E(x) of the unconfirmed store x based on the distance. Therefore, it is possible to simulate a selection behavior in a state in which restriction conditions are imposed. In particular, according to this aspect, the distance between the stores x is set as the restriction conditions. Therefore, it is possible to prevent a distant store x from being selected. As a result, it is possible to reproduce a selection behavior of avoiding a visit to the distant store F12.

In each of the above-mentioned aspects, additional effects or modification examples can be easily derived by those skilled in the art. The broad aspects of the invention are not limited to the above mentioned and described specific details and representative embodiments. Therefore, various modifications and changes of the invention can be made without departing from the scope or spirit of the overall concept of the invention defined by the appended claims or their equivalents.

For example, the restriction conditions set when the selection behavior is simulated are not limited to the above-mentioned content. For example, a budget for purchasing items may be the restriction condition. That is, a desired purchase price may be set as the expected value in advance and the selling price conformed by a clerk may be compared as the evaluation value with the expected value to select a selection candidate. At that time, for example, in a case in which the selling price is less than the expected value in the store that has a bargain sale, the store that sells bargain-priced items is likely to be selected by a dynamic change in the evaluation value.

In addition, the restriction conditions may vary depending on the attribute of the user (for example, age and sex) (for example, the threshold value of the distance between the stores is different in the consumers in their 20s and 50s). Furthermore, the plurality of restriction conditions may be combined with each other. For example, restriction conditions which are combinations of “the remaining time”, “the degree of congestion”, and “the distance between the stores” may be set. Specifically, for example, the evaluation value updated according to the degree of congestion may be compared with the expected value updated according to the remaining time and the distance from the current position to select the store x to be confirmed.

The confirmation order described in each of the aspects is illustrative and may be any order. For example, the confirmation may be sequentially performed from the store x closest to the current position or may be sequentially performed from the store x with the highest expected value E(x). In addition, for example, the confirmation may be sequentially performed from the store x with a high expected value E(x) according to a remaining shopping time.

In a case in which parameter values set as the restriction conditions vary from hour to hour, the evaluation value Ev(x) may be updated at a predetermined time interval. For example, in a case in which the degree of congestion C(x) of the store x is used as the restriction conditions, the evaluation value Ev(x) may be updated at a predetermined time interval since the degree of congestion C(x) varies from hour to hour.

In each of the above-mentioned aspects, a scene in which items are purchased in the stores has been described as an example. However, the invention is not limited to the scene in which the store x is selected. That is, the content of each of the above-mentioned aspects can be applied as long as it is associated with the selection behavior of selecting one of a plurality of selection candidates (for example, decision making in a company).

Since the simulation apparatuses 1a, 1b, and 1c perform simulations under the set restriction conditions, the simulation apparatuses 1a, 1b, and 1c can simulate an optimal selection behavior, without confirming all of the stores x in a round-robin manner. Therefore, it is possible to reduce the time and effort to determine the optimal selection behavior of the consumer through simulations. As such, according to the simulation apparatuses 1a, 1b, and 1c of the embodiments, it is possible to reduce the calculation costs of simulations and to reduce the effort or time cost to determine the optimal selection behavior.

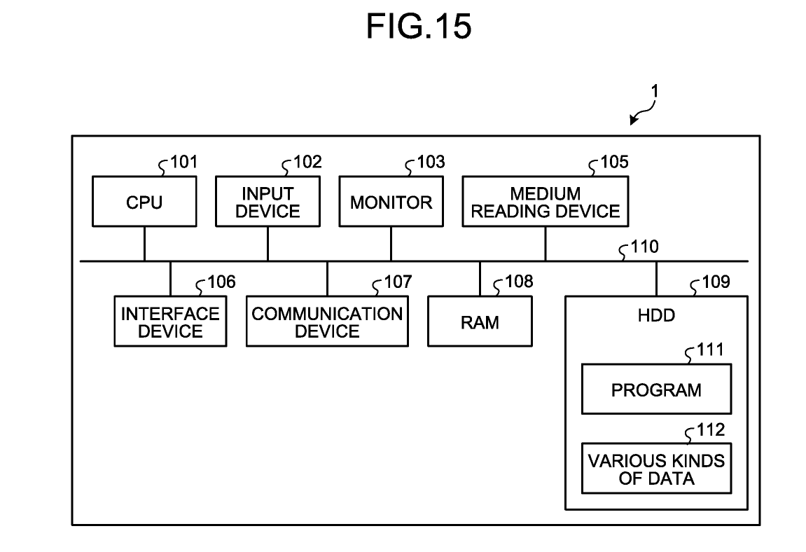

A computer executes a prepared program to implement various processes in each of the above-described embodiments. Next, an example of the computer (hardware) that executes a program having the same functions as those in the above-described embodiments will be described. FIG. 15 is a block diagram illustrating an example of the hardware configuration of the simulation apparatus 1 according to the first embodiment. The simulation apparatuses 1a, 1b, and 1c described in the other embodiments have the same hardware configuration as the simulation apparatus 1.

As illustrated in FIG. 15, the simulation apparatus 1 includes a CPU 101 that performs various types of arithmetic processing, an input device 102 that receives the input of data, and a monitor 103. In addition, the simulation apparatus 1 includes a medium reading device 105 that reads, for example, a program from a storage medium, an interface device 106 for connection to various devices, and a communication device 107 for wireless or wired communication with an external device. The simulation apparatus 1 further includes a RAM 108 that temporarily stores various kinds of information and an HDD 109. In addition, the units (101 to 109) of the simulation apparatus 1 are connected to a bus 110.

The HDD 109 stores a program 111 (simulation program) for performing various processes described in the above-mentioned embodiments. In addition, the HDD 109 stores various kinds of data 112 which are referred to by the program 111. The input device 102 includes, for example, a keyboard, a mouse, and a touch panel that receive operation information input from the operator of the simulation apparatus 1. The monitor 103 displays, for example, various screens operated by the operator. The interface device 106 is connected to, for example, a printing device. The communication device 107 is connected to a communication network such as a local area network (LAN) and exchanges various kinds of information with an external device through the communication network.

The CPU 101 reads the program 111 stored in the HDD 109, expands the program in the RAM 108, and executes the program to perform various processes. In addition, it is possible that the program 111 is not stored in the HDD 109. For example, the simulation apparatus 1 may read the program 111 stored in a storage medium that can be read by the simulation apparatus 1 and may execute the program 111. Examples of the storage medium that can be read by the simulation apparatus 1 include portable recording media, such as a CD-ROM, a DVD disc, and a universal serial bus (USB) memory, a semiconductor memory, such as a flash memory, and a hard disk drive. In addition, the program may be stored in a device that is connected to, for example, a public line, the Internet, or a LAN and the simulation apparatus 1 may read the program from the device and execute the program.

According to one aspect, it is possible to dynamically change the selection behavior of the user.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a simulation program that causes a computer to execute a process comprising:
first directing an agent to visit and evaluate a plurality of selection candidates, the agent making a selection from the plurality of candidates, the agent evaluating the plurality of candidates by utilizing an expected value preset to each of the plurality of selection candidates;
second directing the agent to determine whether to continue visiting and evaluating the plurality of candidates, based on evaluation results of visited selection candidates and the expected values of an unvisited selection candidates; and
third directing the agent to make a selection from the plurality of selection candidates based on the evaluation results of the visited selection candidates in a case in which the agent determines not to continue visiting and evaluating.

2. The non-transitory computer-readable recording medium according to claim 1, wherein, in the confirmation, the evaluation value is calculated based on the expected value and a variance of the expected value.

3. The non-transitory computer-readable recording medium according to claim 1, wherein
the process further includes fourth directing the agent to set an expected value to each of the plurality of selection candidates and to set restriction conditions when the selection candidate is selected, and
in the setting of the expected value, the expected value of the unconfirmed selection candidate is updated based on the restriction conditions, or
in the confirmation, the evaluation value calculated by the confirmation is updated based on the restriction conditions.

4. The non-transitory computer-readable recording medium according to claim 3, wherein
in the setting of the restriction conditions, a remaining time is calculated based on an upper limit time for confirming the unconfirmed selection candidate and a time for confirming the confirmed selection candidate, and
in the setting of the expected value, the expected value of the unconfirmed selection candidate is updated based on the remaining time.

5. The non-transitory computer-readable recording medium according to claim 3, wherein
in the setting of the restriction conditions, a degree of congestion of each of the plurality of selection candidates is set, and
in the confirmation, the calculated evaluation value is updated based on the degree of congestion.

6. The computer-readable recording medium according to claim 3, wherein
in the setting of the restriction conditions, a distance between the plurality of selection candidates is set, and
in the setting of the expected value, the expected value of the unconfirmed selection candidate is updated based on the distance.

7. A simulation method comprising:
first directing an agent to visit and evaluate a plurality of selection candidates, the agent making a selection from the plurality of candidates, the agent evaluating the plurality of candidates by utilizing an expected value preset to each of the plurality of selection candidates, by a processor;
second directing the agent to determine whether to continue visiting and evaluating the plurality of candidates, based on evaluation results of visited selection candidates and the expected values of an unvisited selection candidates, by the processor; and
third directing the agent to make a selection from the plurality of selection candidates based on the evaluation results of the visited selection candidates in a case in which the agent determines not to continue visiting and evaluating, by the processor.

8. A simulation apparatus comprising:
a processor configured to:
direct an agent to visit and evaluate a plurality of selection candidates, the agent making a selection from the plurality of candidates, the agent evaluating the plurality of candidates by utilizing an expected value preset to each of the plurality of selection candidates;
direct the agent to determine whether to continue visiting and evaluating the plurality of candidates, based on evaluation results of visited selection candidates and the expected values of an unvisited selection candidates; and
direct the agent to make a selection from the plurality of selection candidates based on the evaluation results of the visited selection candidates in a case in which the agent determines not to continue visiting and evaluating.
